(19) United States
(12) Patent Application Publication
(10) Pub. No.: US 2025/0322994 A1
(43) Pub. Date: Oct. 16, 2025

(54) SOLID ELECTROLYTIC CAPACITOR AND METHOD FOR MANUFACTURING SOLID ELECTROLYTIC CAPACITOR

(71) Applicant: Panasonic Intellectual Property Management Co., Ltd., Osaka (JP)

(72) Inventors: KOJI TAKAHASHI, Kanagawa (JP); HIROYUKI HANDA, Osaka (JP); NOBORU NEGORO, Osaka (JP); SYUSAKU KOIE, Shiga (JP); KENJI KURANUKI, Kyoto (JP)

(21) Appl. No.: 19/252,416

(22) Filed: Jun. 27, 2025

Related U.S. Application Data
(63) Continuation of application No. PCT/JP2024/000628, filed on Jan. 12, 2024.

(30) Foreign Application Priority Data
Jan. 24, 2023 (JP) 2023-008712

(51) Int. Cl. H01G 9/012; H01G 9/028; H01G 9/15

(52) U.S. Cl. CPC H01G 9/012; H01G 9/028; H01G 9/15

(57) ABSTRACT

A solid electrolytic capacitor includes: a plurality of capacitor elements stacked on each other, each of the plurality of capacitor elements including an anode body and a cathode part; two anode terminals electrically connected to the anode body; a cathode terminal electrically connected to the cathode part; and an outer packaging resin. The anode body has two protrusions respectively protruding from both ends of the cathode part. Each of the two protrusions is electrically connected to a corresponding one of the two anode terminals. The two protrusions in each of the plurality of capacitor elements are electrically connected to each other. The cathode terminal includes a mounting surface exposed from the outer packaging resin, and a side wall rising continuously from the mounting surface and electrically connected to a side surface of the cathode part.

### BACKGROUND

### 1. Technical Field

The present disclosure relates to a solid electrolytic capacitor and a method for manufacturing the solid electrolytic capacitor.

### 2. Description of the Related Art

Conventionally, a surface mount capacitor called a transmission line type noise filter is known (for example, Unexamined Japanese Patent Publication No. 2009-076651). The surface mount capacitor of Unexamined Japanese Patent Publication No. 2009-076651 includes a box-shaped resin mold case base, a plurality of stacked capacitor elements each having both ends and a central part, and a box-shaped case lid, both ends each having an anode, the central part having a cathode. The surface mount capacitor further includes a metal plate that is locked to the inside of the case lid and compensates for conduction of the cathodes of the capacitor elements as necessary.

### SUMMARY

One aspect of the present disclosure relates to a solid electrolytic capacitor. The solid electrolytic capacitor includes: a plurality of capacitor elements stacked on each other, each of the plurality of capacitor elements including an anode body and a cathode part formed on a surface of the anode body via a dielectric layer; two anode terminals electrically connected to the anode body; a cathode terminal electrically connected to the cathode part; and an outer packaging resin that covers the plurality of capacitor elements, the two anode terminals, and the cathode terminal so that a part of each of the two anode terminals and a part of the cathode terminal are exposed from the outer packaging resin. The anode body has two protrusions, one of the two protrusions protruding from one of both ends of the cathode part, another one of the two protrusions protruding from another one of the both ends of the cathode part. Each of the two protrusions is electrically connected to a corresponding one of the two anode terminals. The two protrusions in each of the plurality of capacitor elements are electrically connected to each other. The cathode terminal includes a mounting surface exposed from the outer packaging resin, and a side wall continuously rising from the mounting surface and electrically connected to a side surface of the cathode part of each of the plurality of capacitor elements.

Another aspect of the present disclosure relates to a method for manufacturing the above-described solid electrolytic capacitor. The method for manufacturing includes: a first processing step of forming an intermediate product including the two anode terminals and the cathode terminal that are integrated together by performing cutting and bending on a predetermined frame raw material; a stacking step of stacking the plurality of capacitor elements on the intermediate product; a connecting step of electrically connecting portions of the intermediate product corresponding to the two anode terminals to the anode body and electrically connecting a portion of the intermediate product corresponding to the cathode terminal to the cathode part; and a molding step of forming the outer packaging resin by molding the plurality of capacitor elements and the intermediate product with a resin; and a second processing step of forming the two anode terminals and the cathode terminal by performing cutting and bending on the intermediate product.

According to the present disclosure, it is possible to achieve both good noise filter characteristics and case of manufacturing.

Although novel features of the present disclosure are set forth in the appended claims, the present disclosure will be better understood by the following detailed description with the drawings, both as to configuration and content, in conjunction with other objects and features of the present disclosure.

### BRIEF DESCRIPTION OF THE DRAWINGS

FIG. 1 is a side perspective view schematically illustrating an example of a solid electrolytic capacitor according to the present disclosure;

FIG. 2 is a side cross-sectional view schematically illustrating a capacitor element; and

FIG. 3 is a perspective view schematically illustrating a plurality of the capacitor elements and a cathode terminal.

### DETAILED DESCRIPTIONS OF EMBODIMENTS

A surface mount capacitor disclosed in Unexamined Japanese Patent Publication No. 2009-076651 cannot be easily manufactured because of a large number of components. In addition, this type of surface mount capacitor is desired to be further improved in noise filter characteristics.

The present disclosure provides a solid electrolytic capacitor and a method for manufacturing the solid electrolytic capacitor that achieve both good noise filter characteristics and case of manufacturing.

Exemplary embodiment of a solid electrolytic capacitor and a method for manufacturing the solid electrolytic capacitor according to the present disclosure will be described below with reference to examples. However, the present disclosure is not limited to examples described below. In the following description, specific numerical values and materials may be exemplified, but other numerical values and materials may be applied as long as the effects of the present disclosure can be obtained.

### (Solid Electrolytic Capacitor)

The solid electrolytic capacitor according to the present disclosure can be used as, for example, a three-terminal transmission line component having a noise filter function. The solid electrolytic capacitor according to the present disclosure includes a plurality of capacitor elements, two anode terminals, a cathode terminal, and an outer packaging resin. The number of anode terminals may be two or more, and the number of cathode terminals may be one or more.

Each of the plurality of capacitor elements includes an anode body and a cathode part formed on a surface of the anode body via a dielectric layer. A part of the anode body protrudes from each of both ends opposite to each other of the cathode part. Hereinafter, the part of the anode body, which protrudes from each of the both ends of the cathode part, is also referred to as a protrusion. The plurality of capacitor elements are stacked on each other. In each capacitor element, two protrusions of the anode body are electrically connected to each other. Each capacitor element further includes an insulator disposed between the anode body and the cathode part to electrically insulate the anode body and the cathode part from each other. The insulator may be, for example, an insulating tape or an insulating resin.

The anode body may be made of a valve metal. Examples of the valve metal constituting the anode body include aluminum, tantalum, niobium, and titanium. The anode body may be a foil of a valve metal or a sintered body of valve metal particles. The anode bodies adjacent to each other in the stacking direction may be electrically connected to each other.

The dielectric layer covers at least a part of the surface of the anode body. The dielectric layer may be an oxide (for example, aluminum oxide) formed on the surface of the anode body by a liquid phase method such as an anodization or a gas phase method such as vapor deposition and atomic layer deposition. The dielectric layer is formed so as to be interposed at least between the anode body and the cathode part.

The cathode part may include a solid electrolyte layer covering at least a part of surface of the dielectric layer, and a cathode layer covering at least a part of the surface of the solid electrolyte layer. The cathode parts adjacent to each other in the stacking direction may be electrically connected to each other. The solid electrolyte layer may contain a conductive polymer. The solid electrolyte layer may further contain a dopant as necessary.

As the conductive polymer, a known polymer used for a solid electrolytic capacitor, such as a x-conjugated conductive polymer, may be used. Examples of the conductive polymer include polymers having, as a basic skeleton, polypyrrole, polythiophenc, polyaniline, polyfuran, polyacetylene, polyphenylene, polyphenylene vinylene, polyacene, or polythiophene vinylene. Among these polymers, a polymer that has, as a basic skeleton, polypyrrole, polythiophene, or polyaniline is preferable. Also included in the above-mentioned polymers are a homopolymer, a copolymer of two or more types of monomers, and derivatives of these polymers (substitution products having a substituent group). For example, polythiophene includes poly (3,4-ethylenedioxythiophene) and the like. As the conductive polymer, one type may be used alone, or two or more types may be used in combination.

As a dopant, at least one selected from the group consisting of low molecular anions and polyanions is used, for example. Examples of low molecular anion include, but are not particularly limited to, a sulfate ion, a nitrate ion, a phosphate ion, a borate ion, an organic sulfonate ion, and a carboxylate ion. Examples of dopant that generates organic sulfonate ions include benzenesulfonic acid, p-toluenesulfonic acid, and naphthalenesulfonic acid. Examples of polyanion include, for example, a polymer-type polysulfonic acid, and a polymer-type polycarboxylic acid. Examples of polymer-type polysulfonic acid include a polyvinylsulfonic acid, a polystyrenesulfonic acid, a polyallylsulfonic acid, a polyacrylsulfonic acid, and a polymethacrylsulfonic acid. Examples of polymer-type polycarboxylic acid include a polyacrylic acid and a polymethacrylic acid. Polyanions also include a polyester sulfonic acid and a phenolsulfonic acid novolak resin. Meanwhile, polyanions are not limited to those listed above.

The solid electrolyte layer may further contain a known additive agent and a known conductive material other than conductive polymers as necessary. Examples of such a conductive material include at least one selected from the group consisting of conductive inorganic materials such as manganese dioxide and TCNQ complex salts.

The cathode layer may include a carbon layer formed on a surface of the solid electrolyte layer and a conductive material layer formed on a surface of the carbon layer. The conductive material layer may include silver paste. As the silver paste, a composition containing silver particles and a resin component (binder resin) may be used, for example. As the resin component, a thermoplastic resin may be used, but it is preferable to use a thermosetting resin such as an imide resin and an epoxy resin.

Each of the two anode terminals is electrically connected to a corresponding one of the two protrusions of the anode body. In other words, one anode terminal (first anode terminal) is electrically connected to the protrusion protruding from one end of the cathode part, and the other anode terminal (second anode terminal) is electrically connected to the protrusion protruding from the other end of the cathode part. Each of the first anode terminal and the second anode terminal may be divided into two or more parts. The anode terminal may be made of copper, a copper alloy, aluminum, or an aluminum alloy, or may be plated. The first anode terminal and the second anode terminal may be electrically connected to the two protrusions of each anode body of the plurality of capacitor elements. The anode terminal may be electrically connected to the protrusion by caulking, or may be electrically connected to the protrusion by welding (for example, laser welding or resistance welding).

The cathode terminal is electrically connected to the cathode part. The cathode terminal may be electrically connected to each cathode part of the plurality of capacitor elements. The cathode terminal may be electrically connected to the cathode part via a conductive adhesive. The cathode terminal may be made of copper, a copper alloy, aluminum, or an aluminum alloy, or may be plated. The constituent material of the cathode terminal may be the same as or different from the constituent material of the anode terminal. The cathode terminal may be divided into two or more parts.

The outer packaging resin covers the plurality of capacitor elements, the anode terminals, and the cathode terminal such that a part of each of the anode terminals and a part the cathode terminal are exposed from the outer packaging resin. Each of the exposed portions of the anode terminals and the cathode terminal functions as an external terminal of the solid electrolytic capacitor. The outer packaging resin may be made of an insulating resin material. The outer packaging resin may be, for example, a cured product of a thermosetting resin containing an epoxy resin, and may contain a filler as necessary.

The cathode terminal includes a mounting surface exposed from the outer packaging resin, and a side wall rising continuously from the mounting surface and electrically connected to a side surface of each cathode part. In other words, the mounting surface and the side wall are integrally formed together. The mounting surface may be electrically connected to the cathode part of the capacitor element closest thereto. The side wall may be electrically connected to the side surface of each cathode part via a conductive adhesive.

The presence of such a side wall reduces the impedance derived from the resistance component and the inductance component of the cathode terminal, and can improve the noise filter characteristics of the solid electrolytic capacitor. Further, since the side wall is formed integrally with the mounting surface, a cathode terminal including the mounting surface and the side wall can be easily produced by bending a predetermined frame raw material, for example. Hence, the solid electrolytic capacitor according to the present disclosure can achieve both good noise filter characteristics and case of manufacturing.

The cathode terminal may have two or more side walls electrically connected to side surfaces of each cathode part. This configuration makes it possible to further improve noise filter characteristics of the solid electrolytic capacitor as compared with the case in which the side wall is electrically connected to only one side surface of each cathode part. The number of the side walls is not particularly limited.

The cathode terminal may further include an upper wall that is formed integrally with the side wall. The upper wall covers at least a part of an upper surface of the cathode part of the capacitor element farthest from the mounting surface, and is electrically connected to the upper surface. This configuration makes it possible to further improve noise filter characteristics of the solid electrolytic capacitor.

### (Method for Manufacturing Solid Electrolytic Capacitor)

A method for manufacturing a solid electrolytic capacitor according to the present disclosure is a method for manufacturing the solid electrolytic capacitor described above, and the method includes a first processing step, a stacking step, a connecting step, a molding step, and a second processing step.

In the first processing step, an intermediate product that includes the anode terminals and the cathode terminal that are integrated together is formed by performing cutting and bending a predetermined frame raw material.

In the stacking step, a plurality of capacitor elements are stacked on the intermediate product. At this time, the plurality of capacitor elements may be stacked such that the protrusions of the anode body of each capacitor element are respectively placed on the portions of the intermediate product corresponding to the anode terminals, and such that the cathode part of each capacitor element is placed on the portion of the intermediate product corresponding to the cathode terminal.

In the connecting step, portions of the intermediate product corresponding to the anode terminals are electrically connected to the anode body, and the portion of the intermediate product corresponding to the cathode terminal is electrically connected to the cathode part. The former electrical connection may be implemented, for example, by bending the intermediate product. The latter electrical connection may be implemented by using, for example, a conductive adhesive.

In the molding step, an outer packaging resin is formed by molding a plurality of capacitor elements, anode terminals, and a cathode terminal with a resin. In the molding step, a plurality of capacitor elements, anode terminals, and a cathode terminal may be placed in a predetermined mold, and an insulating resin (for example, a thermosetting resin) in a molten state may be injected into the mold and is solidified to form the outer packaging resin.

In the second processing step, the anode terminals and the cathode terminal are formed by performing cutting and bending the intermediate product. In other words, in the second processing step, two or more anode terminals and one or more cathode terminals that are separated from each other are formed by cutting the intermediate product that has been integrated.

In the first processing step, the side wall may be provided on the intermediate product. In this case, the side wall can be used as a guide in the stacking step, and the case of manufacturing the solid electrolytic capacitor can be enhanced.

As described above, according to the present disclosure, the integrated cathode terminal having the side wall can achieve both good noise filter characteristics and case of manufacturing.

Hereinafter, an example of a solid electrolytic capacitor and a method for manufacturing the solid electrolytic capacitor according to the present disclosure will be specifically described with reference to the drawings. The above-described components and steps can be applied to the components and steps of the solid electrolytic capacitor and the method for manufacturing the solid electrolytic capacitor according to an example described below. Components and steps of the solid electrolytic capacitor and the method for manufacturing the solid electrolytic capacitor as an example described below can be changed based on the above description. Matters described below may be applied to the exemplary embodiment described above. Among the components and steps of the solid electrolytic capacitor and the method for manufacturing the solid electrolytic capacitor according to an example described below, components and steps may be omitted that are not essential to the solid electrolytic capacitor and the method for manufacturing the solid electrolytic capacitor according to the present disclosure. Note that the following drawings are schematic and do not accurately reflect the shape and number of actual members.

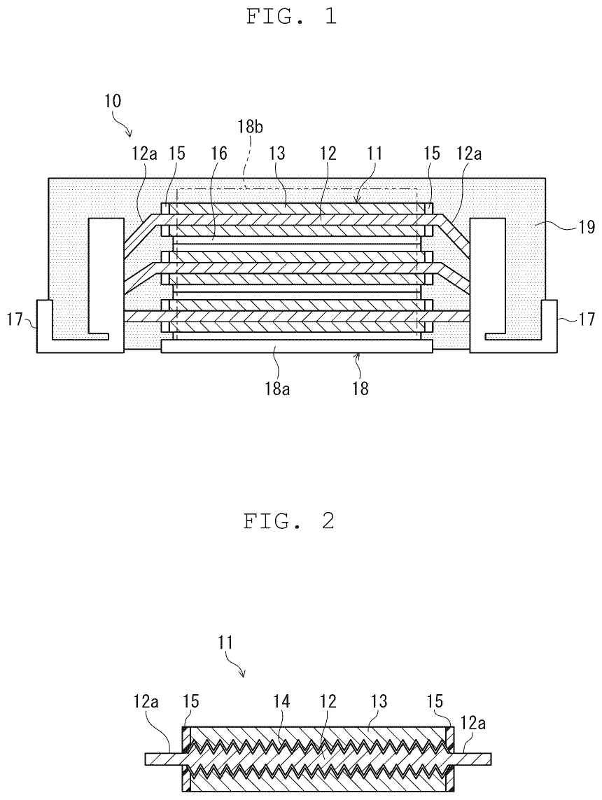

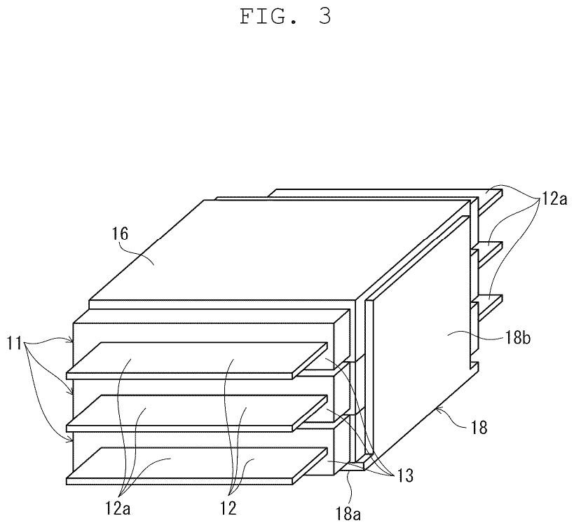

As shown in FIGS. 1 to 3, solid electrolytic capacitor 10 of the present exemplary embodiment includes a plurality of (in this example, three) capacitor elements 11, two anode terminals 17, cathode terminal 18, and outer packaging resin 19. In FIG. 1, side wall 18b to be described later is indicated by a two-dot chain line.

Each of the plurality of capacitor elements 11 has anode body 12 and cathode part 13 formed on a surface of anode body 12 via dielectric layer 14. A part of anode body 12 protrudes from each of both ends (left and right ends in FIG. 1) opposite to each other of cathode part 13. Hereinafter, the part of anode body 12 protruding from each of the both ends of cathode part 13 is also referred to as protrusion 12a. The plurality of capacitor elements 11 are stacked on each other. In each capacitor element 11, two protrusions 12a of anode body 12 are electrically connected to each other. Each capacitor element 11 further includes insulator 15 disposed between anode body 12 and cathode part 13 to electrically insulate anode body 12 and cathode part 13 from each other.

Anode body 12 is made of a foil of a valve metal (in this example, aluminum), but is not limited thereto. Anode bodies 12 adjacent to each other in the stacking direction are electrically connected to each other. Therefore, all anode bodies 12 are electrically connected to each other.

Dielectric layer 14 covers at least a part of a surface of anode body 12. Dielectric layer 14 is made of oxide (in this example, aluminum oxide) formed on the surface of anode body 12 subjected to the roughening treatment, but is not limited thereto.

Cathode part 13 includes a solid electrolyte layer covering at least a part of the dielectric layer 14, and a cathode layer covering at least a part of the solid electrolyte layer. Cathode parts 13 adjacent to each other in the stacking direction are electrically connected to each other via conductive paste 16. Accordingly, all cathode parts 13 are electrically connected to each other. The solid electrolyte layer contains a conductive polymer and a dopant.

Cathode layer includes a carbon layer formed on the surface of the solid electrolyte layer and a conductive material layer formed on the surface of the carbon layer. The conductive material layer may include silver paste.

Each of two anode terminals 17 is electrically connected to a corresponding one of two protrusions 12a of anode body 12. Anode terminal 17 is made of a copper alloy, but are not limited thereto. Anode terminal 17 is electrically connected to protrusion 12a by caulking. Meanwhile, anode terminal 17 may be welded to protrusion 12a instead of or in addition to the caulking.

Cathode terminal 18 is electrically connected to cathode part 13 via, for example, a conductive adhesive. Cathode terminal 18 is made of a copper alloy, but is not limited thereto. The constituent material of cathode terminal 18 is the same as the constituent material of anode terminal 17.

Outer packaging resin 19 covers the plurality of capacitor elements 11 and anode terminals 17, and cathode terminal 18 such that a part of each anode terminal 17 and a part of cathode terminal 18 are exposed from outer packaging resin 19. Each of exposed portions of anode terminals 17 and cathode terminal 18 functions as an external terminal of solid electrolytic capacitor 10. The outer packaging resin 19 is made of an insulating resin material containing a filler.

Cathode terminal 18 has mounting surface 18a exposed from outer packaging resin 19, and side wall 18b that rises continuously from mounting surface 18a and is electrically connected to a side surface of each cathode part 13. Mounting surface 18a is electrically connected to cathode part 13 of closest (lowermost in FIG. 1) capacitor element 11. Side wall 18b is electrically connected to a side surface of each cathode part 13 via a conductive adhesive (not illustrated).

Cathode terminal 18 preferably has two or more side walls 18b each electrically connected to a corresponding one of the opposite side surfaces (side surfaces on the front and back sides of paper in FIG. 1) of each cathode part 13.

### (Method for Manufacturing Solid Electrolytic Capacitor)

Next, a method for manufacturing solid electrolytic capacitor 10 according to the present exemplary embodiment will be described. The method for manufacturing includes a first processing step, a stacking step, a connecting step, a molding step, and a second processing step.

In the first processing step, an intermediate product (not illustrated) that includes anode terminals 17 and cathode terminal 18 that are integrated together is formed by performing cutting and bending a predetermined frame raw material (not illustrated).

In the stacking step, the plurality of capacitor elements 11 are stacked on the intermediate product. At this time, the plurality of capacitor elements 11 are stacked such that protrusions 12a of anode body 12 of each capacitor element 11 are respectively placed on the portions of the intermediate product corresponding to anode terminals 17, and such that cathode part 13 of each capacitor element 11 is placed on the portion of the intermediate product corresponding to cathode terminal 18.

In the connecting step, the portions of the intermediate product corresponding to anode terminals 17 are electrically connected respectively to protrusions 12a of anode body 12 of each capacitor element 11, and the portion of the intermediate product corresponding to cathode terminal 18 is electrically connected to cathode part 13 of each capacitor element 11. The former electrical connection may be implemented by bending the intermediate product. The latter electrical connection may be implemented by using a conductive adhesive.

In the molding step, outer packaging resin 19 is formed by molding the plurality of capacitor elements 11, anode terminals 17, and cathode terminal 18 with a resin. In the molding step, the plurality of capacitor elements 11, anode terminals 17, and cathode terminal 18 are placed in a predetermined mold (not illustrated), and an insulating resin in a molten state is injected into the mold and is solidified to form an outer packaging resin.

In the second processing step, anode terminals 17 and cathode terminal 18 are formed by performing cutting and bending the intermediate product. In the second processing step, two anode terminals 17 and cathode terminal 18 that are separated from each other are formed by cutting the intermediate product that has been integrated.

In the first processing step, it is preferable to provide two or more side walls 18b on the intermediate product. In this case, side walls 18b can be used as guides in the stacking step.

### <<Supplementary Note>>

The above description of the exemplary embodiment discloses techniques below.

### (Technique 1)

A solid electrolytic capacitor, including:
a plurality of capacitor elements stacked on each other, each of the plurality of capacitor elements including an anode body and a cathode part formed on a surface of the anode body via a dielectric layer;
two anode terminals electrically connected to the anode body;
a cathode terminal electrically connected to the cathode part; and
an outer packaging resin that covers the plurality of capacitor elements, the two anode terminals, and the cathode terminal so that a part of each of the two anode terminals and a part of the cathode terminal are exposed from the outer packaging resin,
wherein:
the anode body has two protrusions, one of the two protrusions protruding from one of both ends of the cathode part, another one of the two protrusions protruding from another one of the both ends of the cathode part,
each of the two protrusions is electrically connected to a corresponding one of the two anode terminals,
the two protrusions in each of the plurality of capacitor elements are electrically connected to each other, and
the cathode terminal includes:
   a mounting surface exposed from the outer packaging resin; and
   a side wall continuously rising from the mounting surface and electrically connected to a side surface of the cathode part of each of the plurality of capacitor elements.

### (Technique 2)

The solid electrolytic capacitor according to Technique 1, wherein:
two side walls are provided in the cathode terminal, each of the two side walls being the side wall, and
each of opposite side surfaces of the cathode part is electrically connected to a corresponding one of the two side walls.

### (Technique 3)

The solid electrolytic capacitor according to Technique 1 or 2, wherein the cathode part includes a solid electrolyte layer that covers at least a part of the dielectric layer, the solid electrolyte layer containing a conductive polymer.

### (Technique 4)

A method for manufacturing the solid electrolytic capacitor according to any one of Techniques 1 to 3, the method including:
a first processing step of forming an intermediate product including the two anode terminals and the cathode terminal that are integrated together by performing cutting and bending on a predetermined frame raw material;
a stacking step of stacking the plurality of capacitor elements on the intermediate product;
a connecting step of electrically connecting portions of the intermediate product corresponding to the two anode terminals to the anode body and electrically connecting a portion of the intermediate product corresponding to the cathode terminal to the cathode part;
a molding step of forming the outer packaging resin by molding the plurality of capacitor elements and the intermediate product with a resin; and
a second processing step of forming the two anode terminals and the cathode terminal by performing cutting and bending on the intermediate product.

### (Technique 5)

The method for manufacturing a solid electrolytic capacitor according to Technique 4, wherein in the first processing step, the side wall is provided in the intermediate product.

### EXAMPLES

Solid electrolytic capacitors 10 of an example and a comparative example described below were each subjected to characteristic evaluation. Specifically, for solid electrolytic capacitors 10 of the example and the comparative example, each noise reduction amount was evaluated when a noise signal of 100 MHz was input from one anode terminal 17 to another anode terminal 17.

### EXAMPLES

Solid electrolytic capacitor 10 of the type shown in the above exemplary embodiment was evaluated. The noise reduction amount was −79.2 dB. The noise level was 62%, where the noise level of the solid electrolytic capacitor of the comparative example was 100%.

### COMPARATIVE EXAMPLE

The solid electrolytic capacitor was evaluated that has the same configuration as solid electrolytic capacitor 10 of the example except that cathode terminal 18 had no side wall 18b. The noise reduction amount was −75.0 dB.

As described above, the solid electrolytic capacitor 10 of the example had a remarkably higher noise reduction amount than the solid electrolytic capacitor of the comparative example. This demonstrates superiority of the example.

Although the present disclosure is described in terms of the preferred exemplary embodiment at present, such disclosure should not be construed in a limiting manner. Various modifications and alterations will undoubtedly be apparent to those skilled in the art belonging to the present disclosure by reading the above disclosure. Therefore, the scope of claims appended is to be construed to cover all modifications and alterations without departing from the true spirit and scope of the present disclosure.

The present disclosure can be used for a solid electrolytic capacitor and a method for manufacturing the solid electrolytic capacitor.

What is claimed is:

1. A solid electrolytic capacitor comprising:
a plurality of capacitor elements stacked on each other, each of the plurality of capacitor elements including an anode body and a cathode part formed on a surface of the anode body via a dielectric layer;
two anode terminals electrically connected to the anode body;
a cathode terminal electrically connected to the cathode part; and
an outer packaging resin that covers the plurality of capacitor elements, the two anode terminals, and the cathode terminal so that a part of each of the two anode terminals and a part of the cathode terminal are exposed from the outer packaging resin,
wherein:
the anode body has two protrusions, one of the two protrusions protruding from one of both ends of the cathode part, another one of the two protrusions protruding from another one of the both ends of the cathode part,
each of the two protrusions is electrically connected to a corresponding one of the two anode terminals,
the two protrusions in each of the plurality of capacitor elements are electrically connected to each other, and
the cathode terminal includes:
a mounting surface exposed from the outer packaging resin; and
a side wall continuously rising from the mounting surface and electrically connected to a side surface of the cathode part of each of the plurality of capacitor elements.

2. The solid electrolytic capacitor according to claim 1, wherein:
two side walls are provided in the cathode terminal, each of the two side walls being the side wall, and
each of opposite side surfaces of the cathode part is electrically connected to a corresponding one of the two side walls.

3. The solid electrolytic capacitor according to claim 1, wherein the cathode part includes a solid electrolyte layer that covers at least a part of the dielectric layer, the solid electrolyte layer containing a conductive polymer.

4. A method for manufacturing the solid electrolytic capacitor according to claim 1, the method comprising:
a first processing step of forming an intermediate product including the two anode terminals and the cathode terminal that are integrated together by performing cutting and bending on a predetermined frame raw material;
a stacking step of stacking the plurality of capacitor elements on the intermediate product;
a connecting step of electrically connecting portions of the intermediate product corresponding to the two anode terminals to the anode body and electrically connecting a portion of the intermediate product corresponding to the cathode terminal to the cathode part;
a molding step of forming the outer packaging resin by molding the plurality of capacitor elements and the intermediate product with a resin; and
a second processing step of forming the two anode terminals and the cathode terminal by performing cutting and bending on the intermediate product.

5. The method for manufacturing a solid electrolytic capacitor according to claim 4, wherein in the first processing step, the side wall is provided in the intermediate product.
